(19) United States
(12) Patent Application Publication
(10) Pub. No.: US 2004/0209375 A1
(43) Pub. Date: Oct. 21, 2004

(54) Control bracketing and results hold

(75) Inventors: Kouakou Diby, Rivervale, NJ (US); Lawrence A. Baker, Brookfield, CT (US); James V. Freeman, Sandy Hook, CT (US); Judith Banta, Mahopac, NY (US); Paula Mallon, Morris Plains, NJ (US)

Correspondence Address: RODMAN RODMAN, 7 SOUTH BROADWAY, WHITE PLAINS, NY, 10601

(73) Assignee: BAYER HEALTHCARE, Tarrytown, NY

(21) Appl. No.: 10/817,998

(22) Filed: Apr. 5, 2004

Related U.S. Application Data
(60) Provisional application No. 60/463,101, filed on Apr. 15, 2003.

(51) Int. Cl. G01N 35/02

(52) U.S. Cl. 436/50; 422/67

(57) ABSTRACT

An automated immunoassay analyzer, or assay system, provides for frequent testing of control samples to verify that before and after a series of tests of patients' samples, the operation of the test equipment is accurate, thereby ensuring that the results of the series of patient tests are accurate. Operating the immunoassay analyzer in this manner will delay reporting clinical test results until the results are confirmed as accurate. This operation can be performed automatically by a random access immunoassay analyzer.

This application claims the benefit of U.S. Provisional Application No. 60/463,101 filed Apr. 15, 2003.

### BACKGROUND OF THE INVENTION

This invention relates to automatic testing of biological samples, for example, the use of an immunoassay analyzer for medical tests on human subjects and, more particularly, to coordinating the testing of control samples with the testing of patient samples to insure accuracy of the patient sample test results.

Testing of biological material is widely employed in the practice of medicine, as well as in other disciplines wherein information about biological material is required. Of particular interest is automated testing for the presence of disease in samples of biological material from human patients. Such testing is frequently accomplished by the use of automated equipment, such as an immunoassay analyzer, wherein samples of bodily fluids obtained from patients are aspirated into the testing machinery which then performs tests and provides the results of those tests.

The testing and reporting of the results must be performed accurately to insure that patients receive proper treatment, and to avoid faulty diagnosis of the patient's condition. In order to insure accuracy in the testing procedure, equipment employed in the testing process must be calibrated to ensure that vital parameters, such as the amount of fluid aspirated in a test sample, the temperature of an aspirated sample, and other parameters determined by the testing equipment are measured correctly.

In order to ensure the necessary accuracy in the testing procedure, control samples of known material, often referred to as controls, are tested in the test equipment, such as the immunoassay analyzer. The control samples typically contain biological material of known composition, to ensure that the testing equipment is operating properly and providing the correct results. For example, control tests can include the determination of the amount of acidity in the control material, or the presence of spectral lines in a spectroscopy examination of the control material.

Generally, the calibration and control runs are made before starting the patient's tests, such as at the beginning of the day. Then, the results of patient tests conducted during the day can be presumed to be valid. However, test equipment can gradually lose accuracy during a day of testing. This presents a problem because the results of tests conducted later in the day may be invalid or inaccurate. Thus, there is a need for a procedure to provide improved monitoring of the operation of the testing equipment on a relatively continuous basis to ensure that the testing equipment is operating accurately even after a relatively short series or run of patient tests.

### SUMMARY OF THE INVENTION

In accordance with the present invention an automated immunoassay analyzer, or assay system, provides for frequent testing of control samples to verify that before and after a series of tests of patients' samples, the operation of the test equipment is accurate, thereby ensuring that the results of the series of patient tests are accurate. Operating the immunoassay analyzer in this manner will delay reporting clinical test results until the results are confirmed as accurate. This operation can be performed automatically by a random access immunoassay analyzer.

In practicing the invention, the control testing should be performed more frequently than the calibration testing because the immunoassay analyzer tends to retain its calibration ability for longer periods of time than its capability to maintain the accuracy of its performance of the control tests.

Accordingly, the calibration test is performed before and after a relatively long series of patient tests, whereas the control testing is performed before and after a relatively short series of patient tests. For example, it can be desirable to run a series or set of control tests once every hour, wherein the interval of time between sets of control tests may be based on experience in operating the immunoassay analyzer.

The result of a control test can be referred to as an index representing a numerical value. The control test index can be described with reference to a window or range of acceptable indices such that, depending on the specific test, a control test index is required to fall within the window. The result of a patient test can also be referred to as an index.

In a preferred embodiment of the invention, three different control tests are, performed where the indices are to fall within the window, and a single control test can be provided for an index falling below the lower boundary of the window, and a further single control test can be provided for an index falling above the upper boundary of the window.

The procedure of the invention can be demonstrated with respect to the control testing, wherein a sequence of successive runs of patient tests is bracketed or interleaved with a sequence of sets of control tests. Thus, a set of control tests precedes and follows a run of patient tests. For example, a first set of control tests and a second set of control tests bracket a first run of patient tests.

After the second set of control tests, the patient tests are resumed until a third set of control tests is run. Thus, the second and the third set of control tests bracket the second run of patient tests. The two sets of control tests that bracket a specific run of patient tests must show proper operation of the immunoassay analyzer in order to validate the results of the run of patient tests, and enable the reporting of the results of the patient tests.

In the event that the analyzer has not performed the set of control tests that follow a run of patient tests over an extended period of time, for example, 10 hours, then the results of the patient tests of that run are discarded because the late testing of controls may not represent the current status of the analyzer for patient tests conducted several hours earlier.

It is recognized that an interval of incubation time that can vary from about 15 to about 45 minutes is required after the aspiration of a set of control tests in order to establish the results of the control tests. To save time, it can be desirable to resume the patient testing, rather than wait until the results of the control tests have been established. Thus, patient sample aspirations do not have to await control test results before starting, only that the control has already been aspirated.

If the control tests show a defective analyzer, then the results of the patient testing in the run of patient tests which preceded the defective control results, as well as the results of the patient testing in the run of patient tests which followed the defective control results are discarded.

By interleaving or bracketing the sequence of runs of patient tests with the sequence of control tests, the immunoassay analyzer, or other material testing device can automatically perform the task of ensuring the accuracy of the patient test results before reporting the results.

### BRIEF DESCRIPTION OF THE DRAWINGS

In the drawings:

FIG. 1 is a simplified flowchart showing the procedure of the invention for interleaving a sequence of tests during the performance of an immunoassay analyzer with a sequence of runs of patient tests for confirming the accuracy of the results of the patient tests prior to reporting the results;

FIG. 2 is a timing diagram showing bracketing runs of patient tests with sets of control tests to implement the procedure of FIG. 1;

FIG. 3 is a schematic diagram of an immunoassay analyzer operating in accordance with the procedure of the invention; and

FIG. 4 is a simplified flowchart similar to FIG. 1, showing additional options and features of the invention.

Identically labeled elements appearing in different figures refer to the same element but may not be referred to in the description for all figures.

### DETAILED DESCRIPTION OF THE INVENTION

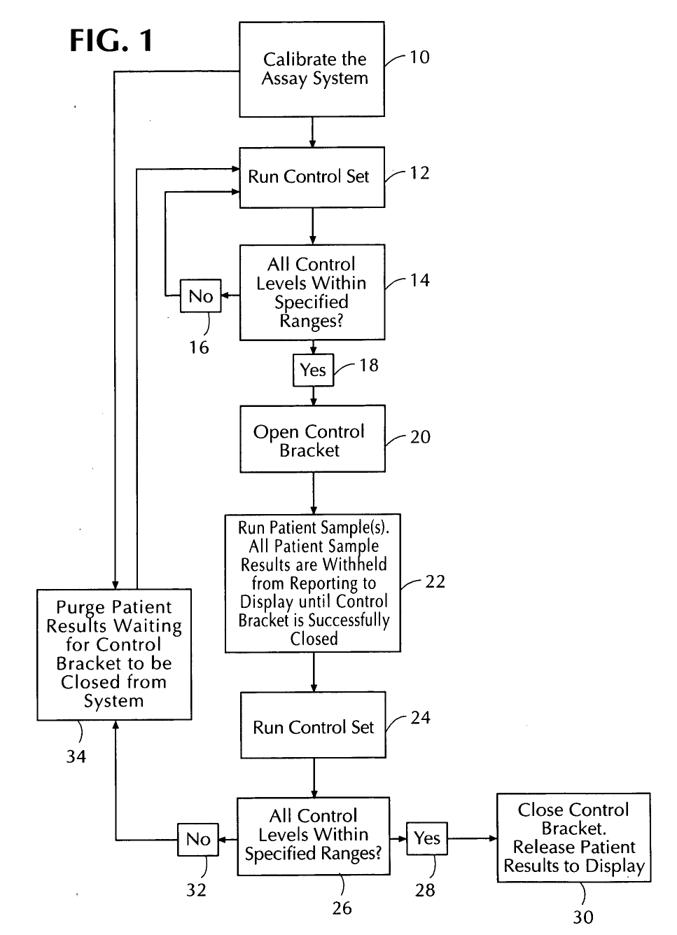

With reference to FIG. 1, the procedure of the invention is applicable to the operation of an assay system, such as a sample-testing apparatus, and more particularly to the automated immunoassay analyzer employed in a preferred embodiment of the invention. The procedure begins at block 10 with a calibration of the assay system. Typically, the calibration test will determine whether the volume of a quantity of liquid or the acidity of the liquid (pH value), for example, is being correctly measured by the assay system equipment. In the case of the automated immunoassay analyzer, the calibration test can involve aspirating a known quantity of liquid from a sample followed by comparing the measured value of the quantity of liquid with the known quantity.

The results of the calibration step can be awaited before proceeding with block 12 or, if desired, one can proceed immediately to block 12 and run a control set of system tests. If the results of the calibration tests are awaited before running the control set, the control set would be run after a successful completion of the calibration tests. Calibration tests are used to establish measurement parameters, whereas control tests are used to make sure that the analyzer is operating properly with the established parameters.

If the calibration tests indicate a problem with the assay system, appropriate adjustments would be made to obtain proper calibration prior to running the control set. However, if the assay system had been recently tested, and it is presumed that the assay system is operating properly, some patient tests can be conducted with the results withheld until the results of the calibration and of the control set have been ascertained. Thereafter, the results can be provided to the patient or to the health-care provider, such as by use of a display or printer of the assay system. If there is a failure of a calibration test or a failure of a test of the control set, the patient tests would need to be rerun, and the results of the prior patient tests would be discarded.

For example, at block 12, the control set of tests can consist of four samples of known material to be applied to four separate tests with four separate reagents and possibly a spectrographic test. In the use of the control set, the correct results are known beforehand. Thus, if the assay system produces the correct results from the tests, the outputting of the correct results is an indication of proper and accurate operation of the assay system.

Each test of the control set is formulated to provide a numerical result that must fall within a range of values. For example, a numerical result must fall within a window of acceptable results, the window extending from a lower limit to an upper limit of acceptable values. Alternatively, an acceptable value must fall in a range below an upper limit or in a range above a lower limit.

Thus, in the case of an automated assay system, the system has a computer to compare the results of a control test with the acceptable range of values and outputs an indication of a successful test or a failed test. Similarly, in the case of a calibration test run in block 10, the computer tests a measured value, such as the volume of a liquid or the acidity of the liquid against the known validity criteria to output the indication of a successful test or a failed test.

If both the calibration tests and the control tests are run prior to the inception of the patient testing, the procedure of FIG. 1 advances to block 14 wherein it is determined whether the measured levels in the tests of the control set are within the specified ranges. In the event that the control levels are not within the specified ranges, block 16 is activated and the control set must be rerun at block 12. In the event that the control levels are within the specified ranges, block 18 is activated and the procedure advances to block 20 wherein a control bracket is opened.

The terminology “control bracket” is employed to indicate a set of patient sample tests preceded by a control set and followed by a control set. The “opening” of the control bracket initiates the set of patient sample tests. The “closing” of the control bracket terminates of the set of patient sample tests.

At block 22, the set of tests on the patient samples is run. In accordance with one aspect of the invention, the reporting of the test results of the patient samples by means of a display, printout, or other means of communication is withheld until the control bracket is successfully closed.

The “successful closing” of the control bracket means that the concluding set of control tests, which follows the set of the patient tests, indicates that the assay system is operating correctly.

Accordingly, at block 24, the control set that follows the set of the patient tests is activated. At block 26 it is determined whether all the control levels of the control set at block 24 are in the specified ranges. If the control levels are within the specified ranges at block 28, then the control bracket is successfully closed at block 30, and the patient results are released, such as by presentation on a display or printout of the assay system.

In the event that the control levels are not within the specified ranges at block 32, then, at block 34, there is a purging of the patient results from the assay system, and the procedure reverts to block 12 for a running of the control set.

It should also be noted that at the time of the initial calibration of the assay system at block 10, if there are previous patient results that have been withheld, then these patient results should be purged from the assay system at block 34 prior to commencing the running of the control set at block 12. This ensures that there is no inadvertent release of patient data where it has not been ascertained that the data is accurate.

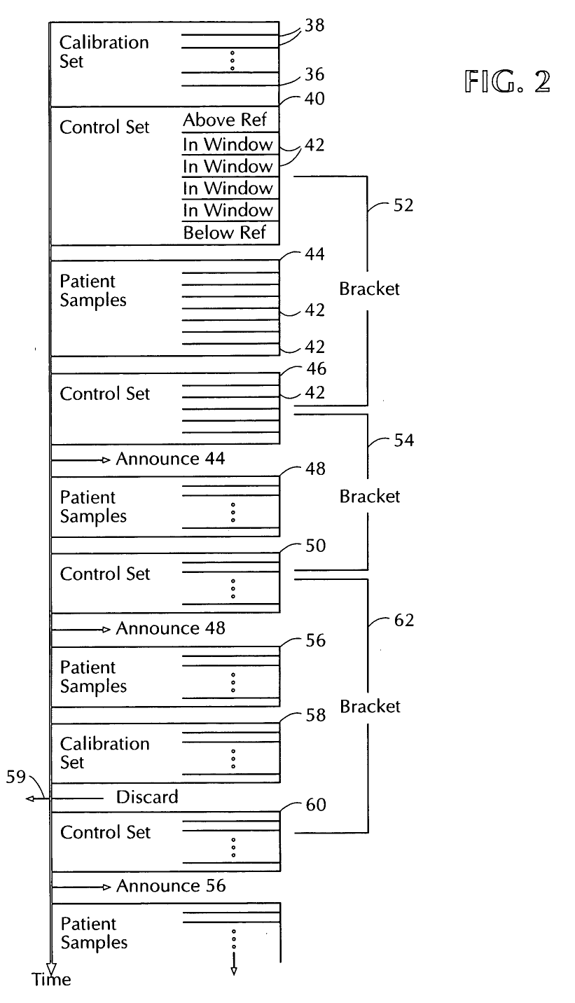

FIG. 2 provides a further description of the invention by means of a timing diagram showing the succession of steps in the procedure. As shown at the top of the diagram, at block 36, the procedure begins with running a set of calibration tests, with individual tests indicated by slots 38.

Upon completion of the calibration tests, the procedure advances to block 40 for performance of the sequence of tests of the control set. Individual tests of the control set are indicated by slots 42.

Upon completion of the control set, the procedure advances to block 44 for performance of the sequence of tests on patient samples. In block 44, slots 42 indicate individual tests. Several slots 42 are indicated by way of illustration to represent that in actual practice of the invention, hundreds of patient samples can be tested in block 44.

Upon completion of the sequence of patient tests of block 44, the procedure continues at block 46, wherein individual tests of the control set are indicated by slots 42. This is followed by a further sequence of testing of patient samples at block 48 which, in turn, is followed by the running of tests of a further control set at block 50.

The sequence of tests of the control set of block 40, which precedes the sequence of the testing of the patient samples at block 44, and the sequence of tests of the control set of block 46, which follows the testing of the patient samples of block 44, are said to bracket the testing of the patient samples of block 44, such bracketing being indicated at 52.

Correspondingly, the control set at block 46 and the subsequent control set at block 50 bracket the testing of the patient samples of block 48, this bracketing being indicated at 54.

The timing diagram of FIG. 2 shows a further testing of patient samples at block 56 followed by calibration tests at block 58 followed by a further control set at block 60. The control sets at the blocks 50 and 60 bracket the patient samples at block 56 as indicated at 62. Upon the successful conclusion of the bracket 52, there is an announcement of the results of the testing of the patient samples at block 44 of the bracket 52. Similarly, there is an announcement of the results of the patient samples of block 48 upon the successful conclusion of its bracket 54, and an announcement of the results of the testing of the patient samples of the block 56 upon a successful conclusion of its bracket 62.

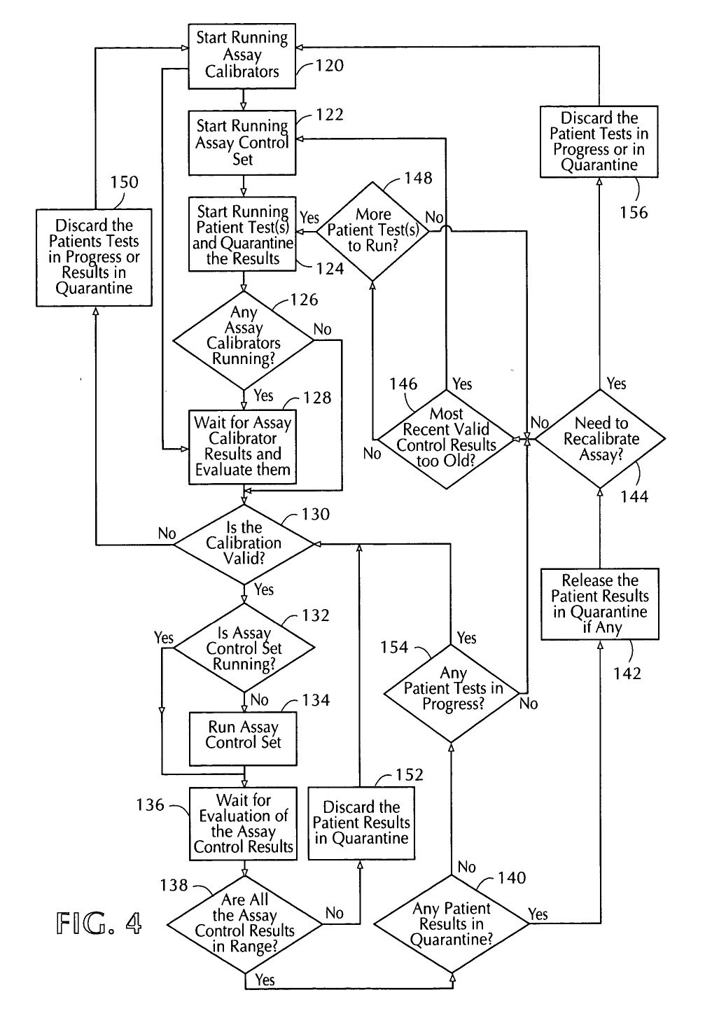

In the event that calibration tests, such as the calibration tests at block 58 of the bracket 62, indicate a need for recalibration, the results of the tests of the patient samples of block 56 are discarded, as indicated at arrow 59, and are not announced. Only samples between control sets using the same accurate calibration parameters are released. The handling of the recalibration situation will be described further with reference to FIG. 4.

FIG. 2 indicates a repetition of the calibration sets of tests at less frequent intervals than the rate of repetition of the control sets of tests. Thus, there is an interleaving of sequences of tests of the calibration sets and of the control sets and of the patient sample sets.

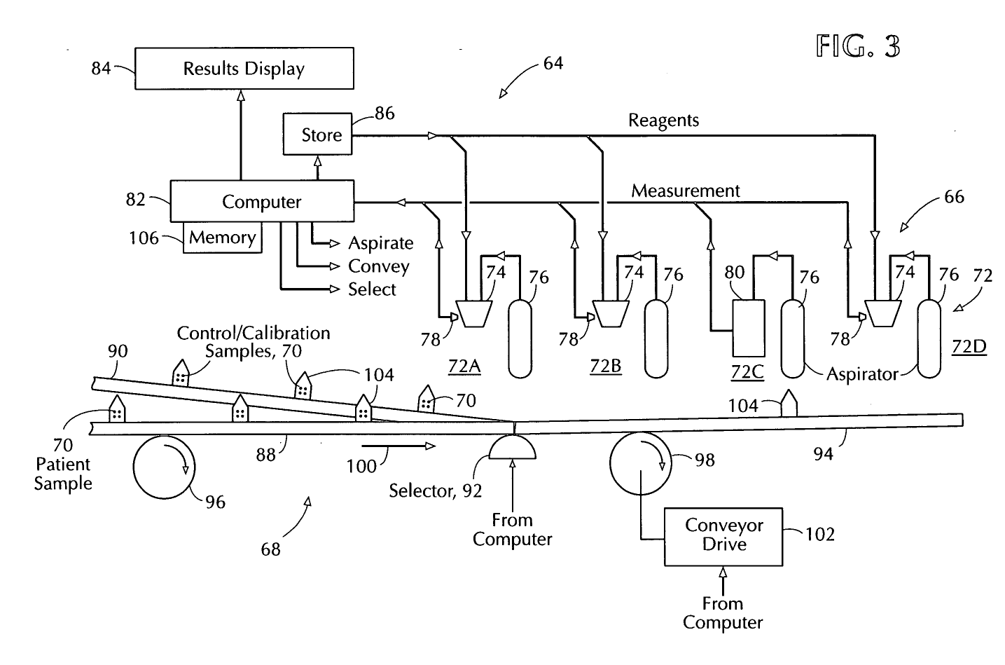

FIG. 3 is a schematic diagram of a system 64 for conducting the procedure of the invention: System 64 generally represents immunoassay equipment including the immunoassay analyzer of the invention. It is understood that the specific components of such equipment may vary depending on the needs of the user of the equipment.

The system 64 comprises testing apparatus 66 and conveyor apparatus 68 for conveying samples 70 to be tested at workstations 72 of the testing apparatus 66. While the system 64 operates automatically, it is understood that the procedure of the invention can also apply to manually operated equipment.

By way of example in the system 64, four workstations 72 are shown. It is understood that a greater or lesser number of workstations can be employed. The four workstations are identified as 72A, 72B, 72C and 72D. Each of the workstations 72A, 72B and 72D includes a vial 74 and an aspirator 76 for extracting into the vial 74 a predetermined portion of a sample to be tested, as well as a sensor 78 for sensing the contents of the vial 74. The workstation 72C, for example, includes an aspirator 76 with a spectrometer 80 for determining the spectral characteristics of an aspirated sample. The testing apparatus 66 also comprises a computer 82, a memory 106, a display 84 for outputting results of a test, and a store 86 for storing reagents to the placed in the vials 74 for conducting the tests.

The conveyor apparatus 68 comprises two input conveyor belts 88 and 90 coupled by a selector 92 to a third conveyor belt 94. The selector 92 can be a mechanical switch which offsets the position of either one of the input belts 88 and 90 to be in alignment with the third belt 94, to thereby enable articles carried by one of the selected input belts 88 and 90 to be passed on to the third belt 94. The conveyor belts 88, 90 and 94 are supported by a plurality of drive rolls, two of which are shown at 96 and 98, for imparting motion to the belts in the direction of arrow 100.

A drive unit 102, operated by signals from the computer 82, is shown connected to the roll 98 for imparting rotation to the roll 98 to carry sample holders 104 along the third conveyor belt 94. It is understood that further connections, not shown, are provided between the drive unit 102 and other drive rolls of the conveyor apparatus 68 for selectively driving the input belts 88 and 90.

The sample holders 104, located on the first input conveyor belt 88, carry patient samples to be tested by the conveyor apparatus 68 while further sample holders 104, located on the second input conveyor belt 90, carry control samples to be tested by the system 64. Some of the control samples on the second input conveyor belt 90 can be employed for conducting the calibration tests of the system 64.

The selector 92 operated by the computer 82 provides for an alternative coupling of sample holders 104 of either the first conveyor belt 88 or the second conveyor belt 90 to the third conveyor belt 94.

In the operation of the system 64, the computer 82 directs the selector 92 to select the samples 70 of the second belt 90 to be coupled onto the third belt 94 for conducting the calibration tests as described above with reference to block 36 of FIG. 2, and also for conducting the tests of a control set as described above with reference to block 40 of FIG. 2.

For conducting tests on patient samples, the computer 82 directs the selector 92 to select the samples 70 of the first belt 88 to be coupled onto the third belt 94 for conducting the patient sample tests as described above with reference to block 44 of FIG. 2.

With respect to conducting any one of the tests, whether a calibration test or a test of the control set, or a patient sample test, the holders 104 contain a known quantity of the samples 70. A sensor 78 in any one of the workstations 72 can be tested during a calibration test by measuring the liquid, or other material, within the respective vial 74. The sensor 78 can also be employed in a control test or a patient sample test to measure the amount of product or other characteristic of a chemical reaction within the respective vial 74. By operation of the selector 92, in combination with activation of the conveyor drive unit 102, the computer is able to sequence the procedures conducted by the system 64 in accordance with the format presented in the timing diagram of FIG. 2.

The computer 82 directs the conveyor drive unit 102 to bring the sample holders 104 to respective locations under the aspirators 76, whereupon the aspirators 76 aspirate predetermined quantities of the samples 70 into the vials 74. Alternatively, a single sample 70 can be processed by successive workstations 72A, 72B, 72C and 72D wherein each workstation performs a separate test on the specific sample. The operation of an aspirator 76 is controlled by the computer 82. The computer also directs the store 86 to inject predetermined amounts of reagents into respective ones of the vials 74.

The chemical reaction between the reagent and the sample in any one of the vials 74 can produce, for example, a change in color, a change in temperature, or a quantity of precipitate which can be sensed by the sensor 78.

In the case of the workstation 72C, material of a sample aspirated by the aspirator 76 is supplied to the spectrometer 80, and spectrographic data outputted by the spectrometer 80 is transmitted to the computer 82. Values sensed by the sensor 78 are transmitted to the computer 82 for evaluating the results of the tests.

In accordance with another aspect of the invention, the results of the tests on the patient samples are held within the memory 106 of the computer 82 until the closing of a bracket, as described in FIG. 2, prior to being transmitted to the display 84.

The results are presented on the display 84, or otherwise communicated such as by being printed by a printer of the display 84 or being transmitted electronically to a remote station, only after a successful closure of the bracket.

As already described, successful closure of the bracket only occurs when the tests of the control sets conducted both before and after a sequence of patient samples tests are found to produce acceptable results.

This is demonstrated in FIG. 2 wherein, after a successful conclusion of the control set of block 46, there may be an announcement of the test results of the patient samples of block 44. Also, after successful conclusion of the control set of block 50 there can be an announcement of the test results of the patient samples of block 48. A program for operation of the computer 82 may also be stored in the memory 106, providing for operation of the system 64 under direction of the computer 82 in accordance with the invention.

FIG. 4 shows procedural operations which are in addition to and alternative to the procedural operations disclosed in FIG. 1. The procedure begins at block 120 with a running of the calibration tests of the immunoassay analyzer. This is followed at block 122 with the running of the control set for the immunoassay analyzer. Thereupon, at block 124, there is a running of the sequence of the patient sample tests, wherein the results of the patient tests are quarantined by holding the results in the computer memory 106 of FIG. 3. In the example of the operation of the assay equipment presented by the sequence of blocks 120, 122 and 124, the patient tests have been run immediately after the running of the calibration tests and the control tests.

In this example, the patient tests have been run before obtaining the results of the calibration tests and the control tests. Therefore, the results of the patient tests are not to be released and are to be withheld, or quarantined, until a later time when the results of the calibration tests, the control tests preceding the patient tests, and a further set of control tests which follow the patient tests have been obtained and are found to be accurate.

Thus, at block 126 it is determined whether any calibration tests are still being run. In the event that calibration tests are still being run, at block 128 the procedure waits until the results of the calibration tests are obtained and evaluated.

In the event that the calibration is found to be valid at block 130, the procedure advances to block 132 where it is determined whether the set of control tests are running. If the control test set is not being run, then at block 134 the control set is run, which is the control set that follows the patient tests of block 124. The procedure then waits for the results of the control tests to be evaluated at block 136. If the results of the control set are in their proper ranges at block 138, the procedure advances to block 140 to observe whether there are any patient test results in quarantine, namely, being stored in the computer memory 106 of FIG. 3.

In the situation under consideration, patient tests were run at block 124, and the results were quarantined. Accordingly, the procedure advances from block 140 to block 142 wherein the patient test results are released from quarantine.

The releasing from quarantine is accomplished in FIG. 3 by a reading of the results from memory 106 for presentation on the display 84.

After announcing the patient test results at block 142, the procedure can then revert via blocks 144, 146 and 148, to run more patient tests at block 124. At block 144 it is determined whether it is necessary to recalibrate the assay equipment. In the situation under consideration, the equipment has been recently recalibrated at block 120. Therefore, it is not necessary to recalibrate at this time, and the procedure advances to block 146 wherein it is determined whether any of the control test results which bracket the patient test results are too old. This is determined by a time comparison. Typical specific time parameters that serve as criteria to recalibrate are about 14 days and to rerun a control test are about 24 hours.

In the situation under consideration, all the control tests were run recently, and the procedure advances to block 148 to determine whether there are additional patient tests to be run. If more patient tests are to be run, then the procedure advances to block 124 for running more patient tests.

It is noted that at any point in the process, when the results of a control set reach a predetermined age, such as 24 hours, all patient tests in progress, as well as patient results which were quarantined after the control results were evaluated, are discarded instantly if still quarantined. This ensures that only recent control test results are employed for ensuring the testing accuracy of the patient samples. A time of 24 hours is generally set for default. However, the user can set the time interval as desired.

Variations in the foregoing procedure are now considered. Previously, at block 126, it was said that the assay calibration tests were still running. However, in the event that the calibration tests are not currently running, the procedure advances from block 126 to block 130 to determine whether the previously completed calibration runs produced valid results.

At block 130, it was previously assumed that the calibration was valid. However, in the event that the calibration tests results are not in their appropriate ranges, the procedure reverts via block 150 to block 120. At block 150 the patient test results which were quarantined are discarded, this being accomplished in FIG. 3 by a dumping or erasing of the patient test results from the memory 106. The calibration tests are then rerun at block 120.

In reference to a further possible situation, one may begin the procedure at block 120 shortly after having run some patient tests, which were properly bracketed by control tests, after which further patient samples were presented for testing. In this situation, it is not necessary to rerun the calibration tests, but simply to check the results of the calibration tests at block 128. This step of the procedure is indicated by a line connecting block 120 with block 128.

In the previous discussion of block 132, it was assumed that the tests of the control set were not running and, accordingly, the tests were run at block 134. In this connection, it is noted that additional sets of the control tests can be run from time to time to insure accuracy of the results of the patient tests. If, at block 132, it were noted that tests of the control set are presently running, then the procedure would advance from block 132 directly to block 136 to await evaluation of the results of the control set.

In the previous discussion of block 138, it was assumed that the results of the control tests were in the proper range, in which case the procedure advanced from block 138 to block 140. However, in the situation wherein there are results of the control tests that are not in the proper ranges, the procedure advances to block 152 wherein the results of the patient tests, which are held in quarantine, are discarded, and the procedure reverts to block 130 to determine if the results of the calibration tests are valid.

In the previous discussion of block 140, it was assumed that there were patient results to be released from quarantine. However, in the situation wherein there are no patient results in quarantine, the procedure advances to block 154 to inquire whether there are any patient tests currently in progress. If patient tests are currently in progress, then the procedure reverts from block 154 to block 130 to determine if the results of the calibration tests are valid. If, at block 154, it is determined that no patient tests are presently in progress, then the procedure advances to block 146 wherein, as described above, it is determined whether the most recent valid control results are too old. The specific time parameters for “too old” are determined by the user. As noted above in a previous example of aging test results, when the results of a control set reach a determined age, such as 24 hours, all patient tests in progress, as well as patient results which were quarantined after the control results were evaluated, were also discarded if still quarantined.

At block 144, in the previous description, it was assumed that there was no need to recalibrate the assay equipment, in which case the procedure advanced to block 146. However, at block 144, if it is determined to be necessary to recalibrate the assay equipment, then the procedure advances via block 156 back to block 120. At block 156, there is a discarding of results of any patient tests which may be in progress or which may be in quarantine, after which the calibration tests of the assay equipment are rerun at block 120.

At block 146, in the previous description, it was assumed that the most recent valid results of control tests were timely. Therefore, the procedure could advance to block 148 to determine if there were more patient tests to be run. However, in the event that results of the most recent control tests are too old, then the procedure reverts from block 146 to block 122 for a rerunning of the tests in the control set. At block 148, if there are no more patient tests to be run, then the procedure recycles back through block 146 in a waiting loop until more patient samples arrive for testing.

It is to be understood that the above described embodiments of the invention are illustrative only, and that modifications thereof may occur to those skilled in the art. Accordingly, this invention is not to be regarded as limited to the embodiments disclosed herein, but is to be limited only as defined by the appended claims.

What is claimed is:

1. A sample testing system comprising:
(a) testing means for analyzing properties and characteristics of samples, said testing means including a workstation with means for extracting and analyzing predetermined portions of samples including:
(i) a first control sample having known properties and characteristics;
(ii) a sample of organism biological material having unknown properties and characteristics;
(iii) a second control sample having known properties and characteristics;
(b) conveyor means cooperable with the testing means, including means for sequencing said samples to the workstation for analyzing samples to obtain test results for each sample in the following order: first control sample, sample of organism biological material, second control sample;
(c) computer means cooperable with the conveyor means and the testing means, including memory means;
(d) program means to enable the computer means to:
(i) compare the test results of the first control sample with its known properties and characteristics of the first control sample to confirm the accuracy of the testing means;
(ii) collect and store the test results for the sample of organism biological material in the memory means, after confirming the accuracy of the first control sample;
(iii) compare the test results of the second control sample with its known properties and characteristics to again confirm the accuracy of the testing means, after collecting and storing the test results for the sample of organism biological material in the memory means.

2. The system of claim 1, including information presentation means cooperable with the computer means to provide a visual presentation of the test results of the sample of organism biological material after the program means confirms the accuracy of the test results for the first and second control samples.

3. The system of claim 1, further comprising extracting means for extracting a predetermined amount of each sample for analysis.

4. The system of claim 3, further comprising measuring means cooperable with the extracting means for measuring a predetermined quantity of an extracted sample, and adjusting means to calibrate the measuring means of the test apparatus.

5. The system of claim 2, wherein the program means withholds test results on the samples of organic biological material until completion of all tests on the control samples that bracket the tests of the samples of organic biological material.

6. The system of claim 5, wherein, upon a failure of a test on any one of the control samples of the bracket, the program means discards the test results of the samples of organic biological material.

7. A method for testing a sample of biological organism material comprising:
(a) testing a first control sample having known properties and characteristics with testing means to analyze the known properties and characteristics of said first control sample to obtain first test results;
(b) comparing the first test results with the known properties and characteristics of the first control sample to confirm the accuracy of the testing means;
(c) after confirming the accuracy of the testing means on the first control sample, testing a sample of biological organism material with the testing means to analyze its properties and characteristics of the biological organism material and to obtain second test results, and storing the second test results while refraining from a disclosure of the second test results;
(d) after storing the second test results, testing a second control sample having known properties and characteristics with the testing means to analyze the properties and characteristics of the second control sample to obtain third test results;
(e) comparing the third test results with the known properties and characteristics of the second control sample to again confirm the accuracy of the testing means;
(f) after confirming the accuracy of the testing means on the second control sample, disclosing the second test results of the sample of biological organism material.

8. The method of claim 7, wherein the sample of biological organism material and the first and second control samples are sequenced to the testing means in a manner wherein the test results obtained for the first and second control samples interleave the test results for the sample of biological organism material.

9. The method of claim 7, further comprising calibrating the testing means.

10. The method of claim 7, further comprising extracting a predetermined amount of each sample by aspiration for analysis by the testing means.

11. The method of claim 7, wherein the test results for each control sample are characterized by an index representing a numerical value.

12. The method of claim 11, wherein a range of acceptable indices falls within a window represented by upper and lower pre-established numerical limits.

13. The method of claim 7, wherein an unacceptable index is represented by a numerical value that is outside the range of acceptable indices.

14. The method of claim 13, wherein when an unacceptable index occurs for the control sample that is tested immediately following the test results of the sample of organism biological material, the test results for the organism sample are discarded.

15. The method of claim 14, wherein after the test results of the sample of organism biological material are discarded, new testing of first and second control samples is initiated to bracket a new test of the organism sample of biological material.

16. The method of claim 7, wherein a first set of control samples precedes a run of samples of organic biological material and a second set of control samples follows a run of the test samples of organic biological material to bracket the test results of the samples of organic biological material, wherein each sequence of test results for the samples of organic biological material are bracketed by tests of the control samples to insure accuracy of the test results of the samples of organic biological material.

17. The method of claim 12, wherein the test results on the samples of organic biological material are withheld from disclosure until completion of all tests on the control samples that bracket the tests of the samples of organic biological material.

18. The method of claim 17, wherein, upon the failure of a test on any one of the control samples of the bracket, the test results of the samples of organic biological material are discarded.
